(19) United States
(12) Patent Application Publication
(10) Pub. No.: US 2016/0114705 A1
(43) Pub. Date: Apr. 28, 2016

(54) CHILD SAFETY SEAT

(71) Applicant: Graco Children's Products Inc., Atlanta, GA (US)

(72) Inventors: Matthew Alan Morgenstern, West Chester, PA (US); Thomas Jake Mitchell, Atlanta, GA (US)

(21) Appl. No.: 14/922,648

(22) Filed: Oct. 26, 2015

Related U.S. Application Data
(60) Provisional application No. 62/068,745, filed on Oct. 26, 2014.
(60) Provisional application No. 62/068,751, filed on Oct. 26, 2014.

(51) Int. Cl. B60N 2/28

(52) U.S. Cl. CPC B60N 2/2851; B60N 2002/2896

(57) ABSTRACT

A child safety seat can include a seat back and a seat bottom. The seat back can be fixedly, removably, and or rotatably coupled to the seat bottom. The seat back can include an adjustable head rest that moves vertically with respect to the seat back. The head rest can include a headrest latching mechanism for adjusting the vertical position of the headrest with respect to the seat back and a fold locking mechanism to selectively position the head rest and lock the seat back orientation in a raised position for use or a folded position for carrying or storage. The head rest can include a single adjustment actuator, such as a pushbutton or lever, to actuate both the latching and locking mechanisms with a single hand for selectively adjusting the headrest position and seat back orientation.

### CROSS-REFERENCE TO RELATED APPLICATIONS

The present application claims priority to and the benefit of U.S. Provisional Patent Application No. 62/068,745, filed on Oct. 26, 2014, entitled “Child Safety Seat with Foldable Seat Back” and U.S. Provisional Patent Application No. 62/068,751, filed on Oct. 26, 2014, entitled “Child Safety Seat with Carry Strap,” the entire contents of each of which are hereby incorporated herein by reference in their entirety.

### FIELD OF THE DISCLOSURE

The present disclosure is generally directed to child safety seats and more particularly to a child safety seat with a carry strap and/or a seat back that can be folded relative to the seat bottom.

### BACKGROUND

Child safety seats are well known in the art. The typical child safety seat is designed to rest on the seat of a vehicle for a child to sit in the vehicle. Many of these types of child safety seats are booster seats for toddlers. The typical booster seat rests on the vehicle seat but the vehicle's safety harness (e.g., seat belt) is employed to secure the seat occupant in the booster seat as well as the seat the booster seat sits on. The seat back on some booster seats is removable, converting the seat to a seat bottom-only booster for larger children.

Booster seats are often moved from car to car or used in different vehicles. Booster seats are also often taken on trips where the booster seat is used on an airplane for the child and then used in a rental car during the family's time away. Some conventional booster seats include an exterior shell that is a one-piece structure that includes both the seat back and seat bottom. These types of booster seats can be fairly cumbersome for transport and travel. In other conventional booster seats, the seat back can be removed from the seat bottom and the seat back and seat bottom can be carried and transported separately. However, this can also be rather cumbersome, as the two components, if detached, must be separately managed, carried, stored, and transported apart from one-another. As a child gets older, only the seat bottom portion of the child safety seat may be needed as a booster seat. The seat bottom can still be cumbersome to hold and carry, especially while trying to carry other things, such as travel bags, shopping bags, a child, or the like.

Other manufacturers have attempted to address this issue by providing a carrying option, such as a plastic handle or a soft-goods handle coupled to the seat soft goods. In one example, a booster seat includes a plastic carry handle attached to the base of the booster seat. Unfortunately, this still requires a user to occupy one of their hands to hold and carry the booster seat, leaving only one hand free to carry other items.

Similarly cumbersome, on some child safety seats, are height-adjustable headrests that require a specific mechanism to operate the adjustment. On some of these child safety seats, the seat back can be folded down onto the seat bottom for compact storage. However, in conventional child safety seats the seat folding functionality requires a different adjustment mechanism. Thus, these types of child safety seats have two separate sets of components for the two different adjustment functions. This adds cost and manufacturing complexity to the child safety seat design. This also adds increased manufacturing cost and operational complexity for the user to operate the child safety seat, requiring the end-user to interact with the seat in multiple locations to activate multiple adjustment mechanisms for controlling the headrest position and folding of the seat back.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a perspective view of one example of a child safety seat constructed in accordance with one example embodiment of the disclosure. FIG. 1B shows a detail of the headrest latching mechanism in accordance with one example embodiment of the child safety seat of FIG. 1.

FIG. 2 is a front elevation view of the child safety seat of FIG. 1, with the headrest in a highest adjusted seating position on the seat back in accordance with one example embodiment of the disclosure.

FIGS. 3 and 4 are additional front elevation views of the child safety seat of FIG. 1, with the headrest in a lowest adjusted seating position on the seat back in accordance with one example embodiment of the disclosure.

FIG. 5 is another front elevation view of the child safety seat of FIG. 1, with the headrest in a still lower adjusted, non-seating or release position in accordance with one example embodiment of the disclosure.

FIG. 6 is a rear elevation view of the child safety seat of FIG. 1, with the headrest in the lowest adjusted seating position in accordance with one example embodiment of the disclosure.

FIG. 7 is another rear elevation view of the child safety seat of FIG. 1 with the headrest in the still lower adjusted, non-seating or release position in accordance with one example embodiment of the disclosure.

FIG. 8 is a partial rear elevation view of the child safety seat of FIG. 1 with the headrest in the lowest adjusted seating position in accordance with one example embodiment of the disclosure.

FIG. 9 is another partial rear elevation view of the child safety seat of FIG. 1 with the headrest in the still lower adjusted, non-seating or release position with the fold pins unlocked or disengaged.

FIG. 10 is a partial side elevation view of the child safety seat of FIG. 1 with the seat back locked in the raised, use position in accordance with one example embodiment of the disclosure.

FIG. 11 is a side elevation view of the child safety seat and locking mechanism of FIG. 1, with the seat back and locking mechanism locked in the folded position in accordance with one example embodiment of the disclosure.

FIG. 12 is a side elevation view of the car seat of FIG. 1 with the seat back locked in the raised, use position in accordance with one example embodiment of the disclosure.

FIG. 13 is a bottom view of one example of a child safety seat bottom, such as that of FIG. 1, or booster seat and carry strap constructed in accordance with one example embodiment of the disclosure.

FIG. 14 is a bottom, perspective view of the child safety seat bottom or booster seat of FIG. 13, with one end of the carry strap attached to another location on the seat bottom in accordance with one example embodiment of the disclosure.

FIG. 15 is another bottom, perspective view of the child safety seat bottom or booster seat of FIG. 13, with the carry strap in a partly extended condition in accordance with one example embodiment of the disclosure.

### DETAILED DESCRIPTION OF THE EXAMPLE EMBODIMENTS

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical, elements throughout.

In certain example embodiments, the disclosed child safety seat utilizes a single interaction point for the parent or care-giver to adjust the headrest height and to fold the seat back down on to the seat bottom. The disclosed example generally utilizes a squeeze handle, button, or other actuator positioned at or near the top of the headrest or elsewhere along the outer surface of the headrest to unlock a headrest latching mechanism and control the headrest position, and to unlock the pivot locking mechanism and control the seat back orientation.

In this example embodiment or in other example embodiments, a child safety seat can also can include a carry strap provided on a part of the child safety seat. The carry strap allows a user to suspend the child safety seat from their shoulder, arm, or other body part to carry the child safety seat, leaving at least both hands and potentially both arms free to carry other items. In one example, the child safety seat disclosed herein can include a spring-loaded retractor to spool up an elongated strap or webbing into a stored state when a free end of the webbing is not attached to an opposing connector located at a point distal from the retractor on the seat structure. The disclosed solution can be used with any one of a one-piece solid shell child safety seats, boosters with separable seat backs and seat bottoms, and/or boosters in a seat bottom-only or backless booster form.

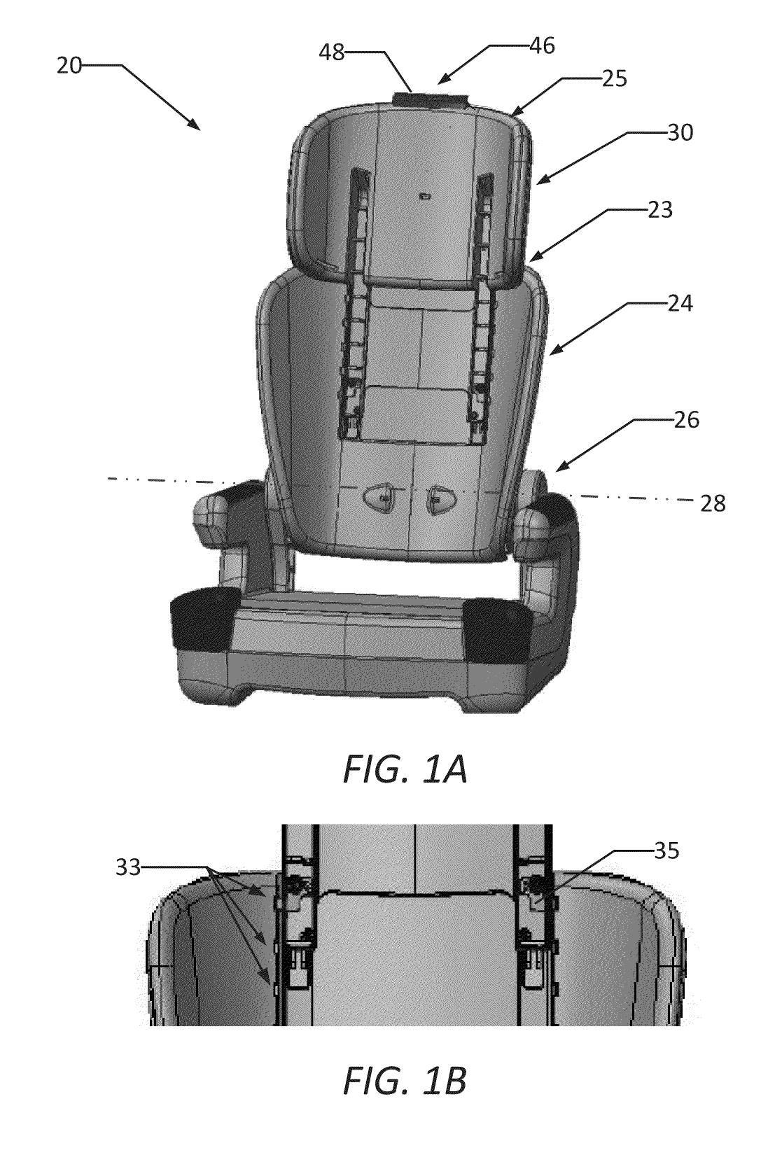

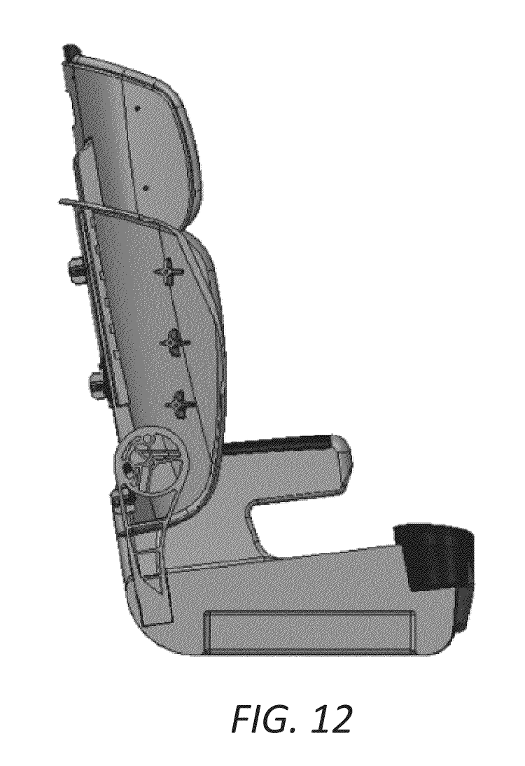

Referring to the drawings, FIGS. 1-12 illustrate an example child safety seat 20. In certain example embodiments, the child safety seat 20 can include a seat bottom 22 and a seat back 24. The seat back 24 may be fixedly, removably, and/or rotatably coupled to the seat bottom 22. In certain example embodiments, as shown in FIG. 11, the seat bottom 22 can be connected to the seat back 24 at a pivot hub 26. In one example, the pivot hub 26 defines a folding or pivot axis 28 between the seat back 24 and the seat bottom 22, as shown in FIG. 1. The child safety seat 20 can also include a headrest 30 movably (either slidably or otherwise adjustably) coupled to the seat back 24 near an upper end 23 of the seat back 24. In certain example embodiments, the headrest 30 can be slidable relative to the seat back 24 so that it is height-adjustable along and relative to the seat back 24. In certain example embodiments, a headrest latching mechanism 46 (described more fully below) allows for the selective adjustment of the headrest 30 position.

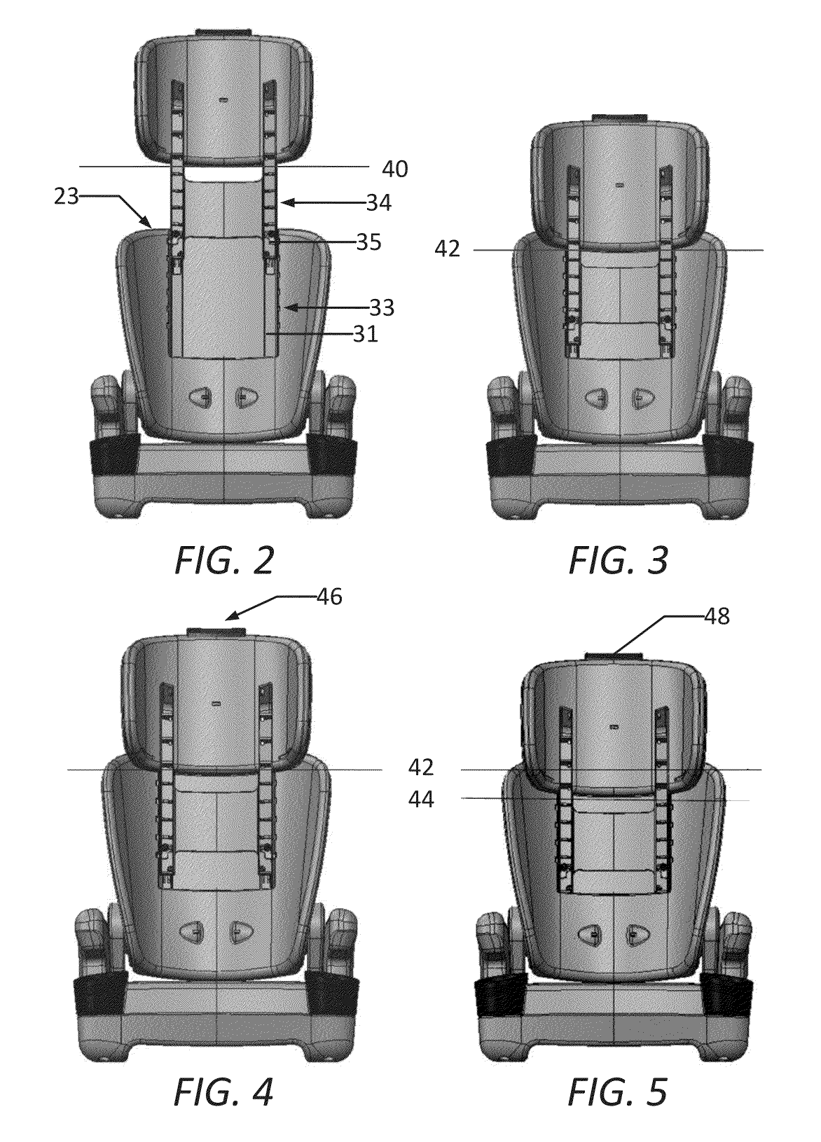

In one example, the headrest 30 is adjustable between at least a highest adjusted seating position 40, as shown in FIG. 2, and a lowest adjusted seating position 42, as shown in FIGS. 3 and 4. The headrest 30 in the highest adjusted seating position 40 accommodates a seat occupant at the tallest or largest end of the occupant size range of the child safety seat 20. The headrest 30 in the lowest adjusted seating position 42 accommodates a seat occupant at the smallest or shortest end of the occupant size range of the child safety seat 20. The headrest 30 can be movable to one or more intermediate adjusted seating positions between the highest adjusted seating position 40 and the lowest adjusted seating position 42 (e.g., among more than just the two adjusted seating positions mentioned above).

In certain example embodiments, the seat back 24 is foldable relative to the seat bottom 22 from a raised, in-use position to a folded position for easy transport and storage. In certain embodiments the headrest 30 is adjustable to a third still lower adjusted, non-seating position, as shown in FIG. 5. The headrest 30 in the still lower adjusted, non-seating position is configured to be too low for accommodating a seat occupant and in one example is significantly lower than the lowest adjusted seating position 42.

In certain examples, the headrest 30 can be manually adjusted to the still lower non-seating position 44 (as shown in FIG. 5) to easily release the seat back 24 by activating the locking mechanism 50, permitting folding of the seat back 24 for transportation or storage as more fully described below. In another exemplary embodiment, the movement of the headrest 30 to the still-lower non-seating position 44 can activate the locking mechanism 50 from the locked condition to the released condition without requiring a user to actuate a separate actuator or mechanism.

In this example embodiment, the headrest 30 further comprises a pair of headrest slide rails 34 that extend vertically or substantially vertically downward along a path parallel to the longitudinal axis of the headrest 30. Each headrest slide rail 34 can be a longitudinally extending rail that include a first end coupled or other wised positioned adjacent to the headrest 30 and a distal second end. The first end of each of the slide rails 34 can be separately connected to the headrest by fasteners, use of a press fit, or adhesive bonding. In an alternate exemplary embodiment, the slide rails 34 and headrest 30 may be manufactured as a single unitary piece through molding or machining In another example, only a single slide rail 34 or track is carried on the headrest 30.

In this example, the seat back 24 contains two slide rail channels 31 that extend downward from an upper surface 23 of the seat back 24 through the interior body of the seat back 24. The slide rail channels 31 are configured to receive the headrest slide rails 34. In this example embodiment, the slide rail channels 31 further include a series of notched recesses 33 along the channel as a component of the headrest latching mechanism 46. Other exemplary embodiments may include recesses in the channel for receiving spring loaded ball detents. In another example, the channel may include embossed ledges, bumps, slots, or other similar features that may interact with components of the headrest slide rails 34 and the headrest latching mechanism 46 to selectively lock the headrest in position.

In this example embodiment, the headrest latching mechanism 46 further includes a headrest adjustment actuator 48, such as a button, lever, or switch, disposed along or otherwise installed on an outer surface of the headrest 30. In one example, the headrest adjustment actuator is disposed along the upper surface 25 of the headrest. The headrest latching mechanism 46 can further include a pivotable headrest fixing member 35 mounted to the slide rail 34, and a linkage (not shown) extending therebetween. The headrest fixing member 35 is configured to mate with the recesses 33 in the seat back 24 slide rail channels 31. The headrest latching mechanism 46 can be spring biased such that in its relaxed, un-activated state the headrest fixing member 35 is pivoted such that it mates with the recess 33, preventing movement of the headrest 30. In certain example embodiments, actuation of the headrest latching mechanism 46 via the adjustment actuator 48 adjusts the height of the headrest 30 and engages a folding mechanism, such as the one or more pin drivers 56, fold pins 54, and pivot hubs 26, for folding the seat back relative to the seat bottom from a raised in-use position to a folded position. For example, when the headrest adjustment actuator 48 is pressed, pulled, turned or otherwise engaged, the linkage pivots the headrest fixing member 35, disengaging it from the recess 33 such that the headrest position can be adjusted by manually pulling up or pushing down on the headrest 30.

In another example embodiment, the headrest latching mechanism 46 may comprise a squeezable handle (not shown) installed on an upper surface 25 of the headrest 30, a headrest fixing member (not shown) installed adjacent to the headrest slide rails 34, and a linkage that extends between the handle and the fixing member. When the handle is not depressed, the fixing member is horizontally disposed such that it contacts the headrest rails 34, latching them in place and preventing movement of the headrest. When the handle is depressed, the linkage retracts the fixing member such that the headrest 30 can move freely between positions. In other exemplary embodiments the headrest latching mechanism 46 may comprise other known or to-be-developed mechanisms.

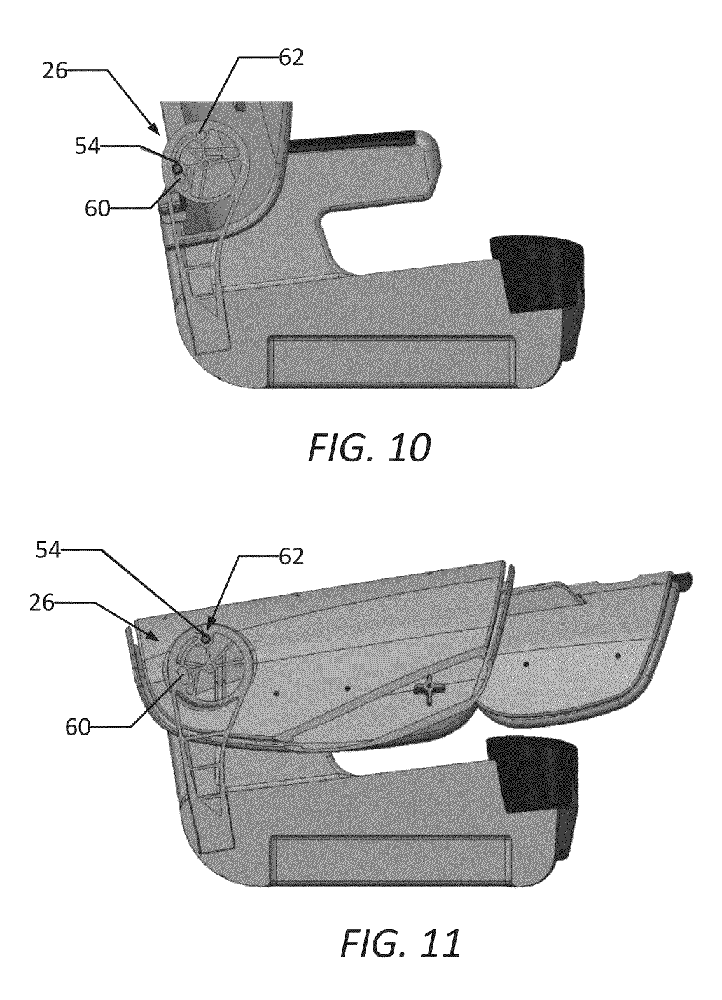

In certain examples, the seat back 24 is pivotally coupled to the seat bottom 22 at the pivot axis 28. In one example, the pivot axis 28 is defined by the pivot hubs 26, as shown in FIGS. 10 and 11. In certain example embodiments, part of each pivot hub 26 is coupled to the seat bottom 22 and part of each pivot hub 26 is coupled to the seat back 24.

In this example embodiment, the child safety seat 20 includes a locking mechanism 50 to prevent unwanted pivoting of the seat back 24. The locking mechanism 50 can be configured to retain the seat back 24 in a fixed position relative to the seat bottom 22, or to keep the child safety seat 20 in a folded position for transportation and storage. In this example embodiment, the locking mechanism 50 prevents pivoting of the seat back 24 in relation to the seat bottom 22 by selectively pinning the seat back 24 portion of the pivot hub 26 in a fixed orientation to the seat bottom 22 portion of the pivot hub 26 as described more fully below.

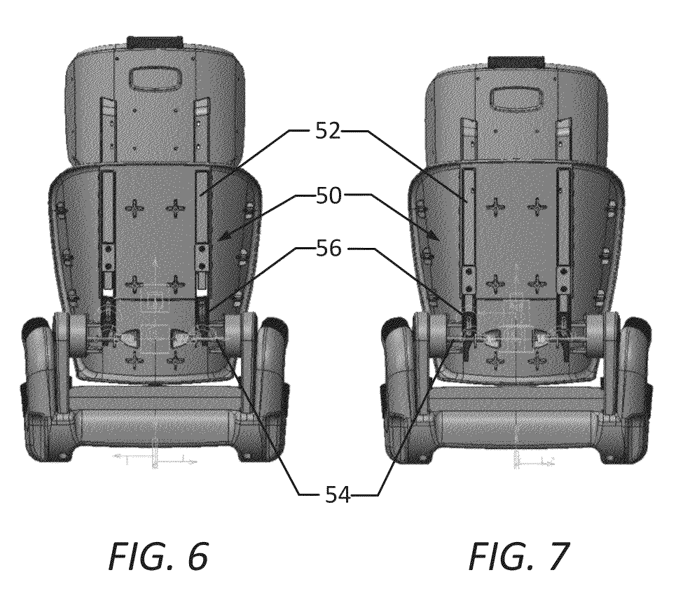

In certain example embodiments, the locking mechanism 50 comprises a number of components carried on the child safety seat 20. With reference to FIGS. 6 and 7, the headrest 30 may include one or more push elements 52 extend coaxially downward from the headrest 30 slide rails 34 along an axis parallel or substantially parallel to the longitudinal axis of the seat back 24. In certain example embodiments, the push elements 52 have the same profile as the slide rails 34 and travel along the slide rail channel 31 freely, but are not attached to the slide rails 34. When the headrest 30 is lowered, the slide rails 34 come in contact with the upper end of the push elements 52 and push them downward as the headrest 30 is lowered further. In another example embodiment, the push element 52 may be attached to the slide rails 34, or may be integrally formed with the slide rails 34.

In this example embodiment, the fold mechanism 50 also includes one or more fold pins 54 mounted parallel to the pivot axis 28. A first end of the fold pins 54 are slidably mounted through an aperture (not shown) in the seat back 24 portion of the pivot hub 26. The second end of the fold pins 54 extend inward towards the central longitudinal axis of the seat back 24 and mates with a first end of an extension spring 57. A second end of the extension spring 57 mates with a spring mount 55 in the seat back and biases the fold pins 54 outward from the central longitudinal axis of the seat back 24, parallel to the pivot axis 28. In this example embodiment, the fold pin 54 further comprises a pin slot 59 that passes through the fold pin 54 perpendicular to the fold pin's 54 longitudinal axis.

The fold mechanism 50 can also include one or more pin drivers 56 carried on the seat back 24 and extending coaxially downward from the push elements 52. Each pin driver 56 can include a first end, a distal second end, and a profiled surface 58 disposed between the first end and the second end. The profiled surface 58 can be configured to contact at least one of the fold pins 54 and cause a corresponding movement in the at least one fold pin 54 in a first direction upon movement of the pin driver 56 in a second direction, wherein the first direction is orthogonal to or substantially orthogonal to the second direction. In one example, the profiled surface 58 can be a ramp, angle, curve, cam, or other profile for creating relative motion between the two components when the pin drivers 56 are moved due to the users upward or downward adjustment of the headrest 30 which in turn causes resultant upward or downward motion of the slide rails 34, and push elements 52. Each of the fold pins 54 may further include a pin driver engagement member, such as a cam follower or other adjustment member. The pin driver engagement member can be disposed between the first end and the distal second end of the fold pin 54 and coupled to the fold pin 54. The pin driver engagement member can further rest or ride along the profiled surface 58 of the corresponding pin driver 58 such than when the pin driver 56 moves in the first direction, the motion of the pin driver engagement member along the profiled surface 58 of the pin driver 56 cause the corresponding movement of the fold pin 54 in the second direction.

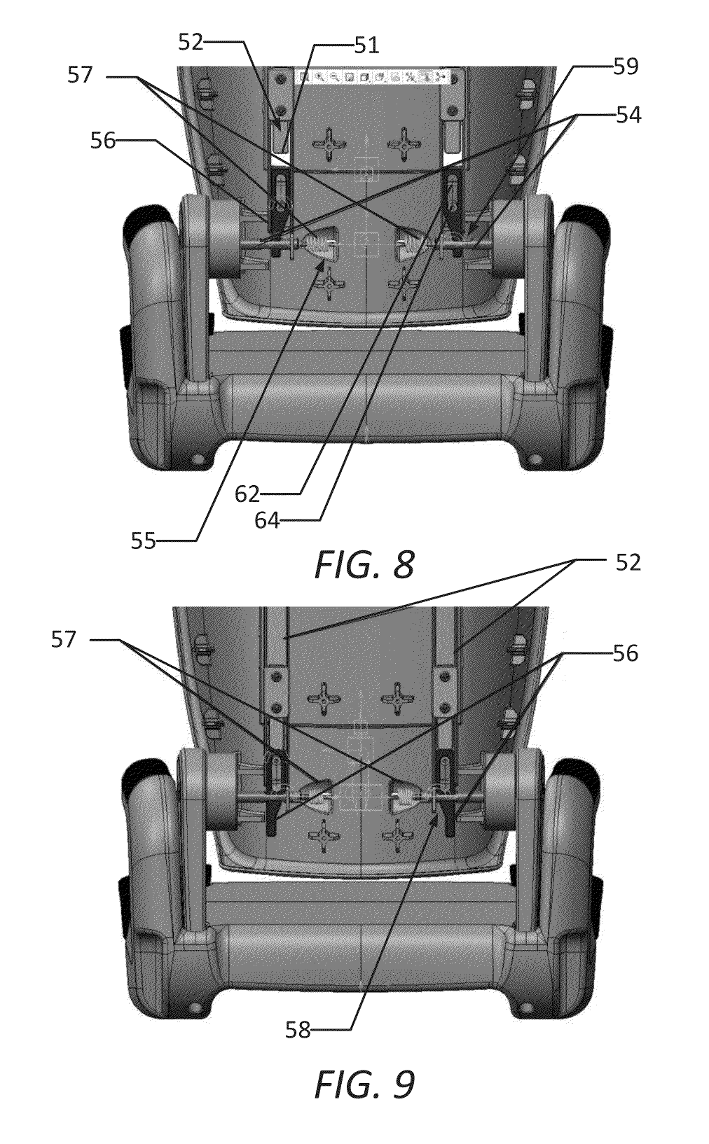

The pin driver 56 has a profiled surface 58, a portion of which contacts part of the respective fold pin 54. In certain examples, the profiled surface 58 may be wedge shaped, ramp shaped, or cam shaped and can pass through a slot 59 in each of the fold pins 54. As the profiled surface 58 of the pin driver 56 passes through the slot 59 in the fold pin 54, the varying surface profile of the pin driver 56 contacts the interior surface of the slot 59 and causes a relative motion of the corresponding fold pin 54. In certain embodiments, each fold pin 54 can be biased outward away from one another, away from a central longitudinal axis of the seat back 24, and toward the respective pivot hub 26 into at least one engaged or locked position. As shown in FIG. 9, when a user further pushes the headrest 30 down to the still lower, non-seating (folding) position, the end of each of the push elements 52 contacts the corresponding pin drivers 56. In this example embodiment, as the pin driver 56 moves downward, the profiled surface 58 causes the fold pins 54 to move axially inward toward a central longitudinal axis of the seat back 24 and retract from the pivot hub 26, allowing the seat back 24 to pivot. With the headrest 30 in the lowest adjusted seating position 42, as in FIG. 8, the ends 51 of the push elements 52 do not contact the pin drivers 56, and thus the spring 57 biases the fold pins 54 outward to engage with the respective pivot hubs 26, fixing the seat back 24 and seat bottom 22 orientation.

In certain example embodiments, the seat back 24 and pin driver 56 contain guide elements to control the range of motion of the pin drivers 56. In one example, as shown in FIG. 8, each pin driver 56 may include a vertical slot 62 allowing the pin drivers 56 to move vertically up and down over a seat back 24 guide pin 64 but prevent lateral movement. In another example, the pin driver 56 may sit within a channel or slot in the seat back 24.

Each pivot hub 26 may include a locking mechanism that includes one or more cavities 60 for receiving at least a portion of one of the respective fold pins 54 which can lock the seat in at least one or more fixed back to seat orientations.

As shown in FIGS. 10 and 11, each pivot hub 26 can have at least one raised position receiver 60 at a radial distance from the pivot axis 28 of the seat back 24. The raised position receiver 60 may be a slot or hole and positioned to receive one end of a respective fold pin 54 and lock the seat back 24 in the raised position, as depicted in FIG. 10. In some example embodiments, the raised position receiver 60 may allow for some play in the seat back 24 so the seat back 24 position is not completely rigid relative to the seat bottom 22 when in the raised position.

Each pivot hub 26 may also include a folded position receiver or hole 62. Each hole 62 is positioned to receive a respective fold pin 54 to lock the seat back 24 in the folded position relative to the seat bottom 22, as depicted in FIG. 11.

In another example embodiment, the seat back 24 may be removably coupled to the seat bottom 22 (not shown). The removable seat back 24 may be configured to have one or more seat back connector parts (not shown) that extend from the seat back 24. For example, the seat back connector parts may extend from a bottom end of the removable seat back 24. The seat bottom 22 may have one or more seat receiver parts (not shown) for selectively coupling with the seat back connector parts. In one example embodiment, the seat back connector parts may include pins and the seat receiver parts may include slots, the pins may be inserted into corresponding slots to secure the seat back 24 to the seat bottom 22. In another example embodiment, a mating feature or snap connection may be integrated in to the seat back connector parts and seat receiver parts such that the seat back 24 and seat bottom 22 securely attach when mated. In a further example, elastic straps may be provided that can be placed over hooks in order to secure the seat back 24 to the seat bottom 22.

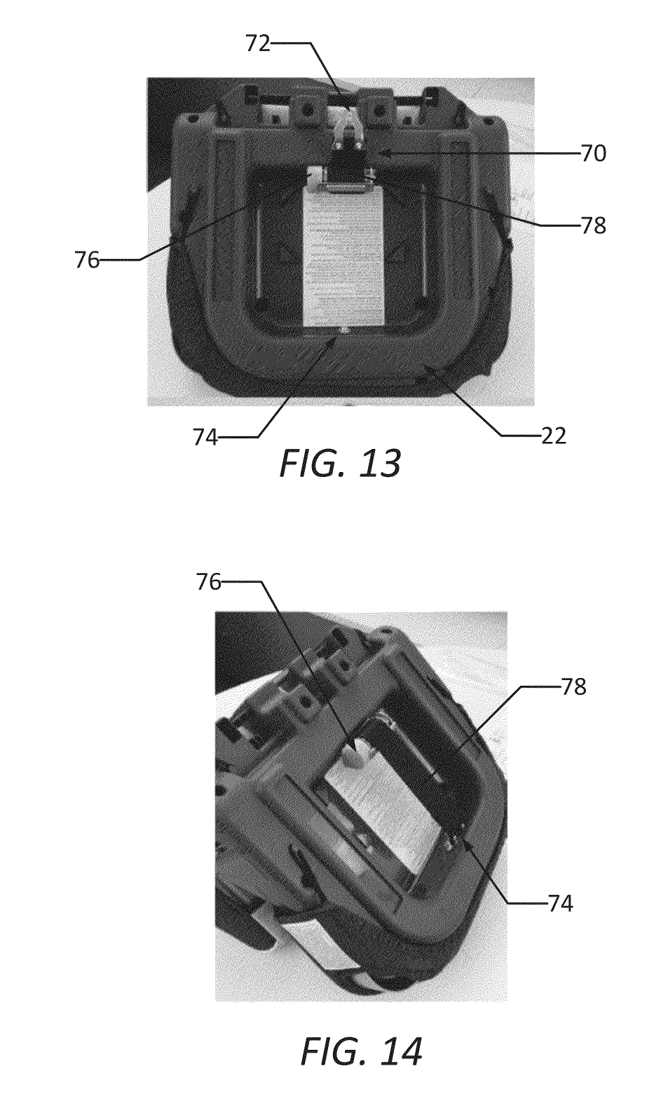

In addition to or separate from the features discussed above with regard to FIGS. 1-12, in certain exemplary embodiments, the child safety seat 20 may further include one or more carry straps. Now referring to FIG. 13, the example child safety seat 20 may include a seat bottom 22 of a booster seat, which may be removably attached to a seat back (not shown) or which can be a backless type booster seat. In this example embodiment, the booster seat has at least a seat bottom 22 structure and a carry strap 70 coupled to the seat bottom 22. For example, the carry strap 70 may be coupled to and disposed along a bottom surface of the seat bottom 22. The bottom side of the seat bottom 22 may include a cavity in which the carry strap 70 is positioned such that when the seat bottom 22 is positioned on a vehicle seat, the carry strap 70 is hidden from view within the cavity and between the surface of the vehicle seat and at least a portion of a bottom surface of the seat bottom 22. In another example, the carry strap 70 could instead be partially connected to, connectable to, or completely connected to a seat back 24 of such a child safety seat 20. The example seat back 24 could be a permanent fixed part of the child safety seat 20 or a removable part of the child safety seat 20. The seat back 24 can also be foldable between a raised use position and a folded position relative to the seat bottom 22.

In one example, the carry strap 70 includes a retractor 76 connected to the underside of the seat bottom 22 within the cavity. The retractor 76 can be spring-biased and can be similar to those used for extending and retracting vehicle seat belt. The retractor 76 can include a strap 78, belt, or webbing having one end connected to the retractor 76 and the opposing end free. The retractor 76 can include a spool onto which the strap, belt, or webbing 78 is wound when retracted. The retractor 76 can also be configured to automatically wind up or tension the strap, belt, or webbing 78. For example, the retractor 76 can wind up or tension the strap, belt, or webbing 78 upon the user activating an automatic or manual release mechanism (not shown). In addition, the retractor 76 can wind up or tension the strap, belt, or webbing 78 upon the user pulling on the strap 78, similar to a window blind, car seat belt, or the like. Further, the retractor 76 can wind up or tension the strap, belt, or webbing 78 automatically when not being used as a carry strap 70. The configuration and construction of the retractor 76 can vary and yet function as intended.

The strap, belt, or webbing 78 can have one end, (e.g., a free end that can be optionally extended by the user from a stored or wound up position to a paid out or extended position, as shown in FIG. 14. The carry strap 70 can be configured to include a connector, clip, or latchplate 72 on the one free end. The child safety seat 20 can also have one or more mating connectors, posts, receivers, buckles, or the like 74 for receiving and/or releasably coupling the connector, clip, or latchplate 72 thereto. These mating connectors, posts, receivers, or the like can be located at one or more positions on the child safety seat 20 distal from the coupling position of the carry strap 70. The connector, clip, or buckle can be configured to attach the one free end of the strap, belt, or webbing 78 to the mating connectors 74. The retractor 76 may keep the strap, belt, or webbing 78 taught, as shown in FIG. 14, even when connected to the mating connector 74. This can be an alternative storage arrangement for the carry strap 70 (the other being shown in FIG. 13 with the strap, belt, or webbing 78 being fully retracted or FIG. 14 with the strap or webbing extended).

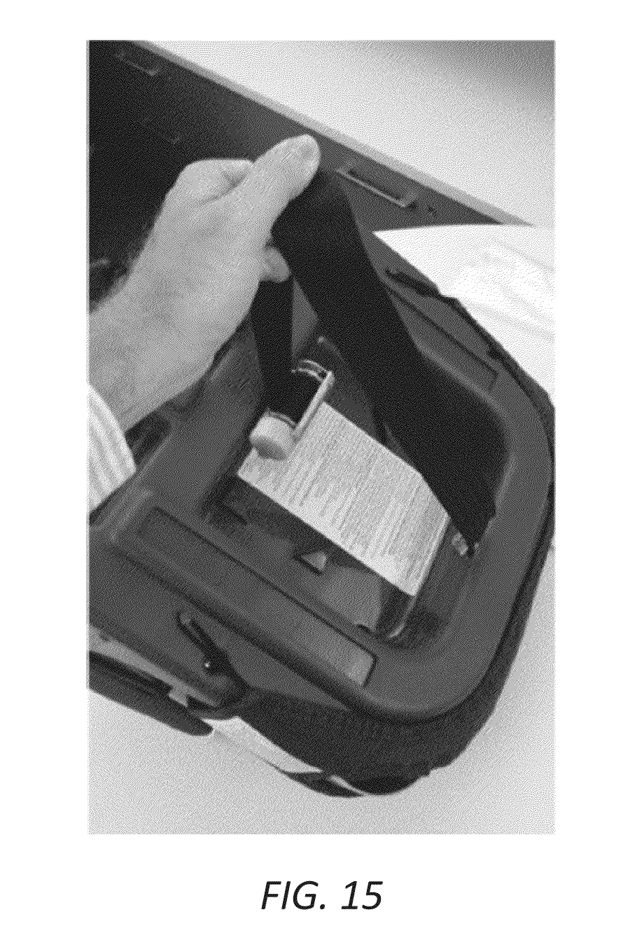

In certain example embodiments, when a user wishes to use the carry strap 70, the user can further extend or pay out the strap, belt, or webbing 78 relative to the child safety seat 20, and in this case, the seat bottom 22 and the retractor 76. With one end of the strap 78 coupled to the retractor 76 and an opposing end 72 connected to a mating connector, post, or buckle 74 (see FIG. 14), the strap 78 can be paid out enough for a user to suspend the strap 78 over their shoulder, arm, neck, or other body part for carrying the booster seat 20, such as is shown in FIG. 15.

In one example, the carry strap 70 and, optionally, a retractor 76, can be mounted to the underside of the seat bottom 22. One end of the webbing or strap can be extendable from the retractor 76 for use. In one example, the one end of the strap or webbing can be selectively connected to the seat bottom 22 or seat back 24 remote from the other end of the carry strap 70 for use. The seat bottom 22 and other portions of the child safety seat 20 can be provided with multiple attachment points for the free end 72 of the strap 78. This would allow the child safety seat 20 to easily accommodate different sized users, different carrying styles, or different arrangements between the extended strap 78 and the seat 20, depending on how a user might wish to carry the seat 20.

The strap, belt, or webbing 78 can include some type of connector element, such as the aforementioned connector, clip or latchplate 72, on the free end. The child safety seat can include one or more corresponding receiving elements 74, such as the aforementioned mating connectors, posts, belt buckle, etc. These elements can be carried on the seat bottom 22, the seat back 24, or both. In certain example embodiments, multiple connector locations 74 can be provided on the seat 20 to provide different optional carry strap 70 arrangements.

In certain alternative example embodiments the retractor 76 may be a manually-operated device for winding up the strap, belt, or webbing 78 when not being used. In another example embodiment, the retractor 76 may be configured to have some automatic wind-up functionality. The retractor 76 can be configured to pay out the carry strap 70 when pulled, to not retract the carry strap 70 when paid out, and to retract the carry strap 70 upon actuation of a retractor release, as described above. The style and function of the release can vary.

Both ends of the strap belt, or webbing 78 can connect or be connectable to either the seat bottom 22 or to the seat back 24. Alternatively, one end of the strap, belt, or webbing 78 can be connected or connectable to each seat part, depending on the style and configuration of the child safety seat 20. The strap, belt, or webbing 78 can be any suitable type of flexible and durable material. The strap, belt, or webbing 78 can be easy to clean. The retractor 76 can be easy to repair or replace. The strap, belt, or webbing can connect to the child safety seat 20 in more than one different arrangement to allow the user to select the arrangement for their use comfort, size, body type, and/or the like.

Though the disclosed example includes a particular arrangement of a number of parts, components, features, and aspects, the disclosure is not limited to only that example or arrangement. Any one or more of the parts, components, features, and aspects of the disclosure can be employed alone or in other arrangements of any two or more of the same.

Although certain child safety seat, locking mechanism, seat back, folding mechanism, adjustment mechanism, carry strap, refractor, and strap, belt, or webbing features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Therefore, in one example embodiment, a child safety seat can include a seat bottom; a seat back comprising an upper end and a lower end, wherein the seat back is coupled to the seat bottom adjacent the lower end; a headrest adjustably coupled to the seat back adjacent the upper end of the seat back, the headrest being height adjustable with respect to the seat back; and a headrest latching mechanism coupled to the headrest and adjustably coupling the headrest to the seat back, the headrest latching mechanism comprising an adjustment actuator disposed along an outer surface of the headrest; wherein actuation of the headrest latching mechanism via the adjustment actuator is configured to adjust the height of the headrest and engages a folding mechanism for folding the seat back relative to the seat bottom from a raised in-use position to a folded position. The child safety seat can further include a carry strap comprising a first end and a distal second end, the first end being operatively connected to the seat bottom; and a mating connector, wherein the carry strap is configured to be removably coupled to the mating connector. The child safety seat can further include a spring-loaded retractor coupled to the seat bottom, wherein the first end of the carry strap is coupled to the spring-loaded retractor and wherein the carry strap is configured to optionally extend from the retractor for use and retracted into the retractor for storage. The first end of the carry strap for the child safety seat can include a latchplate and the matching connector can include a buckle configured to removably couple to the latchplate. The mating connector can be disposed along the seat bottom. Alternatively, the mating connector can be disposed along an outer surface of the seat back. The child safety seat can further include at least two mating connectors, wherein each of the at least two mating connectors is disposed at a different locations on the child safety seat and spaced apart from any of the other at least two mating connectors. The headrest latching mechanism of the child safety seat can include at least one headrest slide rail comprising a first end coupled to the headrest and a distal second end. The folding mechanism of the child safety seat can include at least one pin driver comprising a first end, a distal second end, and a profile surface disposed between a least a portion of the pin driver between the first end and the second end; at least one fold pin comprising a first end and a distal second end, wherein the at least one fold pin is disposed adjacent to the at least one pin driver; and at least one pivot hub disposed adjacent the second end of the at least one fold pin and configured to removably receive the second end of the at least one fold pin. The at least one pin driver can move in a first direction and the at least one fold pin can move in a second direction. In one example the first direction is orthogonal to or substantially orthogonal to the second direction. The second end of the slide rail can be configured to contact the first end of the at least one pin driver and move the at least one pin driver upon at least a portion of the adjustment of the height of the head rest. The pivot hub of the child safety seat can include a locking mechanism that retains the seat back in a raised position relative to the seat bottom in a locked condition and that allows the seat back to move from the raised position to a folded position when in a released condition. The locking mechanism can include one or more first receivers on the pivot hub, each receiver defining the raised position of the seat back, the first receivers configured to receive the second end of one of the at least one fold pins in the raised position; and a corresponding number of second receivers on the pivot hub, each second receiver defining the folded position of the seat back, the second receivers configured to receive the second end of one of the one of the at least one fold pins in the folded a position.

In another example embodiment, a child safety seat can include a seat bottom; a carry strap comprising a first end and a distal second end, the first end being operatively connected to the seat bottom; and a mating connector, wherein the carry strap is configured to be removably coupled to the mating connector. The child safety seat can further include a spring-loaded retractor coupled to the seat bottom, wherein the first end of the carry strap is coupled to the spring-loaded retractor and wherein the carry strap is configured to optionally extend from the retractor for use and retracted into the refractor for storage. The first end of the carry strap can include a latchplate and the matching connector can include a buckle configured to removably couple to the latchplate. The mating connector is disposed along the seat bottom. Alternatively, the child safety seat can include a seat back coupled to the seat bottom, wherein the mating connector is disposed along an outer surface of the seat back.

In yet another example embodiment, the child safety seat can include a seat bottom; a seat back comprising an upper end and a lower end, wherein the seat back is coupled to the seat bottom adjacent the lower end; a headrest adjustably coupled to the seat back adjacent the upper end of the seat back, the headrest being height adjustable with respect to the seat back; a headrest latching mechanism coupled to the headrest and adjustably coupling the headrest to the seat back, the headrest latching mechanism comprising an adjustment actuator disposed along an outer surface of the headrest; a carry strap comprising a first end and a distal second end, the first end being operatively coupled to the seat bottom; and a mating connector, wherein the carry strap is configured to be removably coupled to the mating connector, wherein actuation of the headrest latching mechanism via the adjustment actuator is configured to adjust the height of the headrest and engages a folding mechanism for folding the seat back relative to the seat bottom from a raised in-use position to a folded position.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A child safety seat comprising:
a seat bottom;
a seat back comprising an upper end and a lower end, wherein the seat back is coupled to the seat bottom adjacent the lower end;
a headrest adjustably coupled to the seat back adjacent the upper end of the seat back, the headrest being height adjustable with respect to the seat back; and
a headrest latching mechanism coupled to the headrest and adjustably coupling the headrest to the seat back, the headrest latching mechanism comprising an adjustment actuator disposed along an outer surface of the headrest;
wherein actuation of the headrest latching mechanism via the adjustment actuator is configured to adjust the height of the headrest and engages a folding mechanism for folding the seat back relative to the seat bottom from a raised in-use position to a folded position.

2. The child safety seat of claim 1, further comprising:
a carry strap comprising a first end and a distal second end, the first end being operatively connected to the seat bottom; and
a mating connector, wherein the carry strap is configured to be removably coupled to the mating connector.

3. The child safety seat of claim 2, further comprising a spring-loaded refractor coupled to the seat bottom, wherein the first end of the carry strap is coupled to the spring-loaded retractor and wherein the carry strap is configured to optionally extend from the retractor for use and retracted into the retractor for storage.

4. The child safety seat of claim 2, wherein the first end comprises a latchplate and wherein the matching connector comprises a buckle configured to removably couple to the latchplate.

5. The child safety seat of claim 2, wherein the mating connector is disposed along the seat bottom.

6. The child safety seat of claim 2, wherein the mating connector is disposed along an outer surface of the seat back.

7. The child safety seat of claim 2, further comprising at least two mating connectors, wherein each of the at least two mating connectors is disposed at a different locations on the child safety seat and spaced apart from any of the other at least two mating connectors.

8. The child safety seat of claim 1, wherein the headrest latching mechanism further comprises at least one headrest slide rail comprising a first end coupled to the headrest and a distal second end.

9. The child safety seat of claim 8, wherein the folding mechanism further comprises:
at least one pin driver comprising a first end, a distal second end, and a profile surface disposed between a least a portion of the pin driver between the first end and the second end;
at least one fold pin comprising a first end and a distal second end, wherein the at least one fold pin is disposed adjacent to the at least one pin driver; and
at least one pivot hub disposed adjacent the second end of the at least one fold pin and configured to removably receive the second end of the at least one fold pin.

10. The child safety seat of claim 9, wherein the at least one pin driver moves in a first direction and the at least one fold pin moves in a second direction.

11. The child safety seat of claim 10, wherein the first direction is orthogonal to the second direction.

12. The child safety seat of claim 9, wherein the second end of the slide rail is configured to contact the first end of the at least one pin driver and move the at least one pin driver upon at least a portion of the adjustment of the height of the head rest.

13. The child safety seat of claim 9, wherein the pivot hub comprises:
a locking mechanism that retains the seat back in a raised position relative to the seat bottom in a locked condition and that allows the seat back to move from the raised position to a folded position when in a released condition.

14. The child safety seat of claim 13, wherein the locking mechanism comprises:
one or more first receivers on the pivot hub, each receiver defining the raised position of the seat back, the first receivers configured to receive the second end of one of the at least one fold pins in the raised position; and
a corresponding number of second receivers on the pivot hub, each second receiver defining the folded position of the seat back, the second receivers configured to receive the second end of one of the one of the at least one fold pins in the folded a position.

15. A child safety seat comprising:
a seat bottom;
a carry strap comprising a first end and a distal second end, the first end being operatively connected to the seat bottom; and
a mating connector, wherein the carry strap is configured to be removably coupled to the mating connector.

16. The child safety seat of claim 15, further comprising a spring-loaded retractor coupled to the seat bottom, wherein the first end of the carry strap is coupled to the spring-loaded retractor and wherein the carry strap is configured to optionally extend from the retractor for use and retracted into the retractor for storage.

17. The child safety seat of claim 15, wherein the first end comprises a latchplate and wherein the matching connector comprises a buckle configured to removably couple to the latchplate.

18. The child safety seat of claim 15, wherein the mating connector is disposed along the seat bottom.

19. The child safety seat of claim 15, wherein the child safety seat further comprises a seat back coupled to the seat bottom, wherein the mating connector is disposed along an outer surface of the seat back.

20. A child safety seat comprising:
a seat bottom;
a seat back comprising an upper end and a lower end, wherein the seat back is coupled to the seat bottom adjacent the lower end;
a headrest adjustably coupled to the seat back adjacent the upper end of the seat back, the headrest being height adjustable with respect to the seat back;
a headrest latching mechanism coupled to the headrest and adjustably coupling the headrest to the seat back, the headrest latching mechanism comprising an adjustment actuator disposed along an outer surface of the headrest;
a carry strap comprising a first end and a distal second end, the first end being operatively coupled to the seat bottom; and
a mating connector, wherein the carry strap is configured to be removably coupled to the mating connector,
wherein actuation of the headrest latching mechanism via the adjustment actuator is configured to adjust the height of the headrest and engages a folding mechanism for folding the seat back relative to the seat bottom from a raised in-use position to a folded position.
